(19) United States
(12) Patent Application Publication
(10) Pub. No.: US 2020/0315156 A1
(43) Pub. Date: Oct. 8, 2020

(54) Sanitary Mousetrap Housing Apparatus

(71) Applicant: Nicholas Giacia, Manhattan, NY (US)

(72) Inventor: Nicholas Giacia, Manhattan, NY (US)

(21) Appl. No.: 16/373,015

(22) Filed: Apr. 2, 2019

(51) Int. Cl. A01M 23/30; A01M 23/16

(52) U.S. Cl. CPC A01M 23/30; A01M 23/16

(57) ABSTRACT

A sanitary mousetrap housing apparatus for effectively and sanitarily killing and removing rodents includes a housing having a left side separated from a right side, a back side, and a bottom side. The bottom side has a width configured to receive a mousetrap between the left side and the right side such that the mousetrap can only be slid through either an open top side or an open front side. The bottom side has a length greater than the length of the mousetrap such that no portion of a trapped mouse is exposed past the open front side.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to mousetraps and more particularly pertains to a new mousetrap for effectively and sanitarily killing and removing rodents.

### BRIEF SUMMARY OF THE INVENTION

An embodiment of the disclosure meets the needs presented above by generally comprising a housing having a left side separated from a right side, a back side, and a bottom side. The bottom side has a width configured to receive a mousetrap between the left side and the right side such that the mousetrap can only be slid through either an open top side or an open front side. The bottom side has a length greater than the length of the mousetrap such that no portion of a trapped mouse is exposed past the open front side.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric view of a sanitary mousetrap housing apparatus according to an embodiment of the disclosure.

FIG. 2 is a front elevation view of an embodiment of the disclosure.

FIG. 3 is a rear elevation view of an embodiment of the disclosure.

FIG. 4 is a side elevation view of an embodiment of the disclosure.

FIG. 5 is a top plan view of an embodiment of the disclosure.

FIG. 6 is an isometric view of an embodiment of the disclosure.

### DETAILED DESCRIPTION OF THE INVENTION

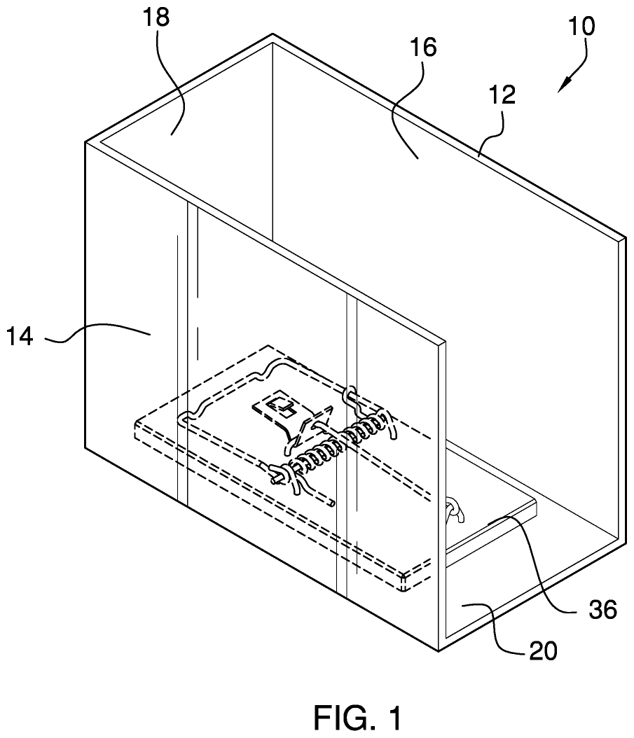

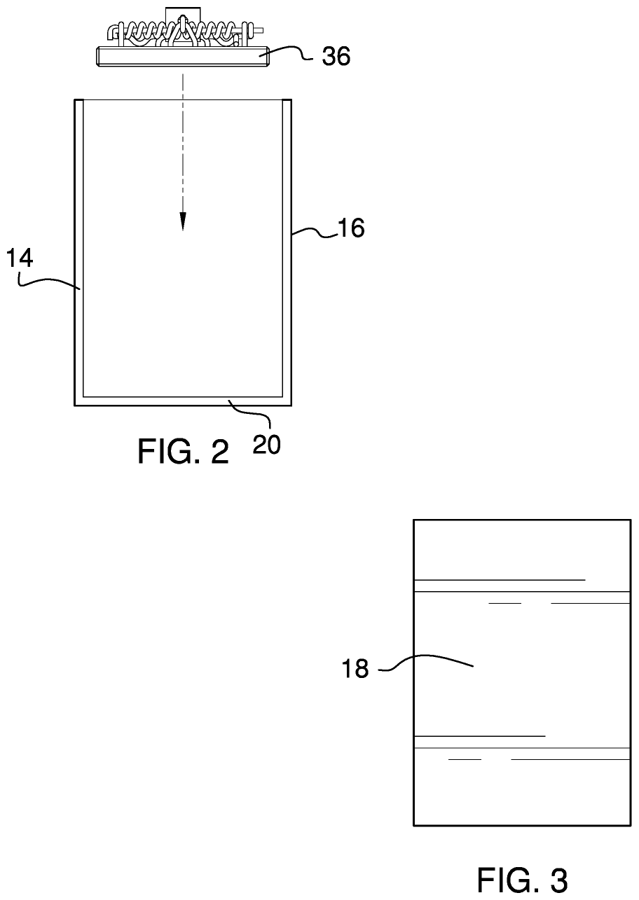

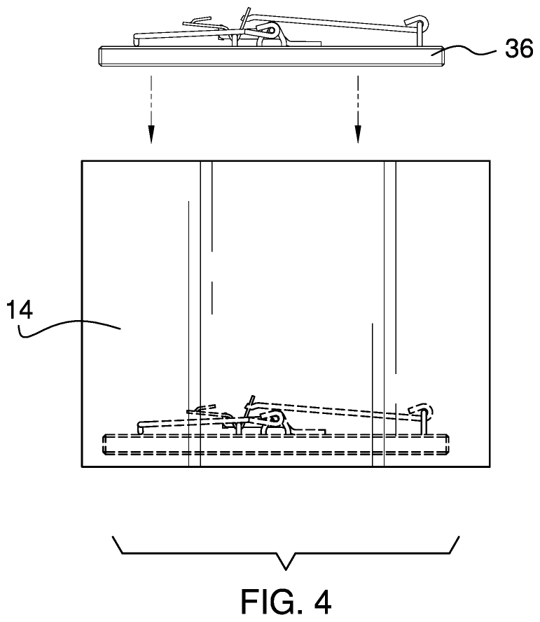

With reference now to the drawings, and in particular to FIGS. 1 through 6 thereof, a new mousetrap embodying the principles and concepts of an embodiment of the disclosure and generally designated by the reference numeral 10 will be described.

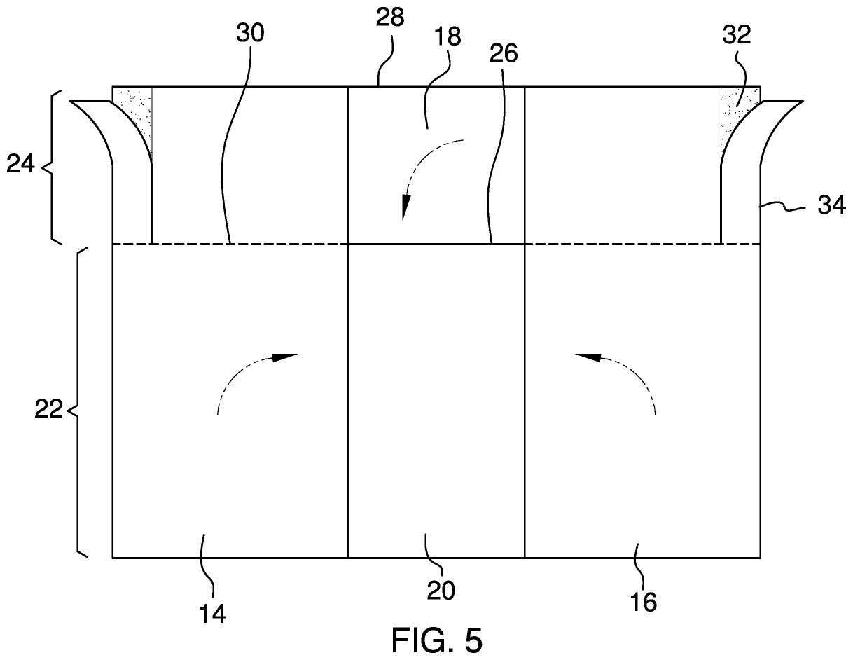

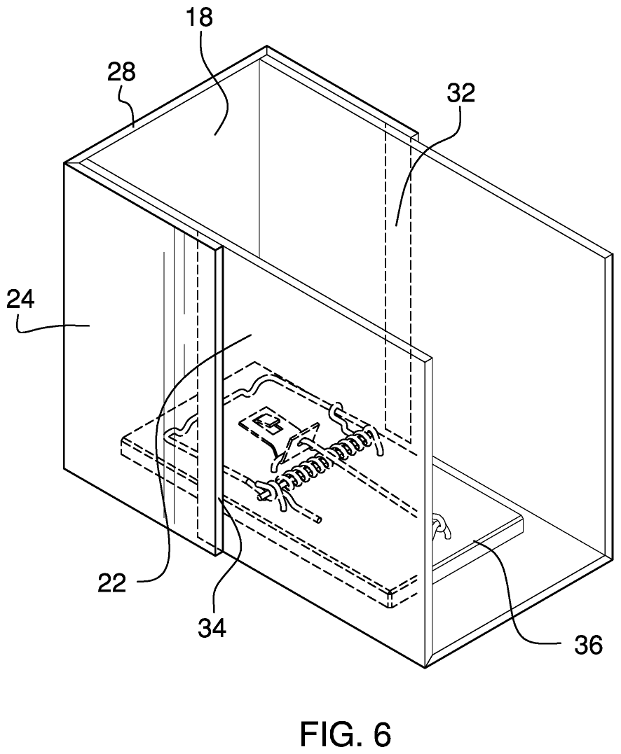

As best illustrated in FIGS. 1 through 6, the sanitary mousetrap housing apparatus 10 generally comprises a housing 12 having a left side 14 separated from a right side 16, a back side 18, and a bottom side 20. The housing 12 may be foldable such that the bottom side 20, the left side 14, the right side 16, and the back side 18 can be flattened to lie coplanar in a pack position (as seen in FIG. 5) and alternatively folded into a rectangular prismatic shape in a use position (as seen in FIG. 6).

The housing 12 may be a complete rectangle when flattened with each of the left side 14 and the right side 16 having a main section 22 and a wing section 24. The main section 22 extends along the length of the bottom side 20 and the wing section 24 extending from a back edge 26 of the bottom side 20 and a top edge 28 of the back side 18. The wing section 24 is cut along a cutline 30 extending colinearly from the back edge 26 such that the wing section 24 remains joined with only the back side 18. The wing section 24 overlaps the main section 22 when the housing 12 is folded into the use position.

An adhesive strip 32 is coupled to the wing section 24 of each of the left side 14 and the right side 16. The adhesive strip 32 extends from an outer edge 34 of the wing section 24 and adheres to the main section 22 when the housing 12 is folded to maintain the use position.

The bottom side 20 has a width configured to receive a mousetrap 36 between the left side 14 and the right side 16 such that the mousetrap 32 can only be slid through either an open top side or an open front side of the housing in the use position. This keeps the mousetrap 36 firmly in place and prevents the mouse from escaping. The bottom side 20 has a length greater than the length of the mousetrap 36 such that no portion of a trapped mouse is exposed past the open front side both for sanitary reasons and to prevent unsightly scenes. The left side 14 and the right side 16 may have a height greater than the width of the bottom side 20 and less than the length of the bottom side 20. The width of the bottom side 20 is ideally between 5.39 cm and 5.72 cm to receive a standard mousetrap and the length of the bottom side is ideally between 10.1 cm and 11.4 cm.

In use, the housing 12 is folded into the use position and the mousetrap 36 is loaded and placed on the bottom side 20 of the housing adjacent the backside 18. Once a mouse is trapped the it is lifted by the housing 12 to avoid contact and is dumped. The housing 12 may also be disposable.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A sanitary mousetrap housing apparatus comprising:
a housing having a left side separated from a right side, a back side, and a bottom side;
the bottom side having a width configured to receive a mousetrap between the left side and the right side such that the mousetrap can only be slid through either an open top side or an open front side, the bottom side having a length greater than the length of the mousetrap such that no portion of a trapped mouse is exposed past the open front side.

2. The sanitary mousetrap housing apparatus of claim 1 wherein each of the left side and the right side have a height greater than the width of the bottom side and less than the length of the bottom side.

3. The sanitary mousetrap housing apparatus of claim 1 wherein the width of the bottom side is between 5.39 cm and 5.72 cm.

4. The sanitary mousetrap housing apparatus of claim 3 wherein the length of the bottom side is between 10.1 cm and 11.4 cm.

5. A combination sanitary mousetrap housing apparatus and mousetrap comprising:
a mousetrap;
a housing having a left side separated from a right side, a back side, and a bottom side;
the bottom side having a width between the left side and the right side substantially conforming to a width of the mousetrap such that the mousetrap can only be slid through either an open top side or an open front side, the bottom side having a length greater than the length of the mousetrap such that no portion of a trapped mouse is exposed past the open front side, each of the left side and the right side having a height greater than the width of the bottom side and less than the length of the bottom side.

6. The sanitary mousetrap housing apparatus of claim 1 wherein the housing is foldable such that the bottom side, the left side, the right side, and the back side can be flattened to lie coplanar in a pack position and alternatively folded into a rectangular prismatic shape in a use position.

7. The sanitary mousetrap housing apparatus of claim 6 wherein the housing is a complete rectangle when flattened, each of the left side and the right side having a main section and a wing section, the main section extending along the length of the bottom side and the wing section extending from a back edge of the bottom side and a top edge of the back side, the wing section being cut along a cutline extending colinearly from the back edge such that the wing section remains joined with only the back side, the wing section overlapping the main section when the housing is folded into the use position.

8. The sanitary mousetrap housing apparatus of claim 7 further comprising an adhesive strip coupled to the wing section of each of the left side and the right side, the adhesive strip extending from an outer edge of the wing section and adhering to the main section when the housing is folded to maintain the use position.

9. A sanitary mousetrap housing apparatus comprising:
a housing having a left side separated from a right side, a back side, and a bottom side, the housing being foldable such that the bottom side, the left side, the right side, and the back side can be flattened to lie coplanar in a pack position and alternatively folded into a rectangular prismatic shape in a use position;
the housing being a complete rectangle when flattened, each of the left side and the right side having a main section and a wing section, the main section extending along the length of the bottom side and the wing section extending from a back edge of the bottom side and a top edge of the back side, the wing section being cut along a cutline extending colinearly from the back edge such that the wing section remains joined with only the back side, the wing section overlapping the main section when the housing is folded into the use position;
the bottom side having a width configured to receive a mousetrap between the left side and the right side such that the mousetrap can only be slid through either an open top side or an open front side of the housing in the use position, the bottom side having a length greater than the length of the mousetrap such that no portion of a trapped mouse is exposed past the open front side; and
an adhesive strip coupled to the wing section of each of the left side and the right side, the adhesive strip extending from an outer edge of the wing section and adhering to the main section when the housing is folded to maintain the use position.

10. The sanitary mousetrap housing apparatus of claim 9 wherein each of the left side and the right side have a height greater than the width of the bottom side and less than the length of the bottom side.

11. The sanitary mousetrap housing apparatus of claim 9 wherein the width of the bottom side is between 5.39 cm and 5.72 cm.

12. The sanitary mousetrap housing apparatus of claim 11 wherein the length of the bottom side is between 10.1 cm and 11.4 cm.
